(19) United States
(12) Patent Application Publication
(10) Pub. No.: US 2002/0060762 A1
(43) Pub. Date: May 23, 2002

(54) Retardation film, substrate for liquid crystal display device using the same, and liquid crystal display device using the retardation film

(75) Inventor: Kouhei Arakawa, Shizuoka-ken (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 09/987,977

(22) Filed: Nov. 16, 2001

(30) Foreign Application Priority Data
Nov. 16, 2000 (JP) 2000-349460
Nov. 16, 2000 (JP) 2000-349475

(51) Int. Cl. G02F 1/1335

(52) U.S. Cl. 349/117

(57) ABSTRACT

A retardation film which can be used as a substrate for a liquid crystal display device, and a liquid crystal display device whose weight and layer thickness can be made, respectively, light and thin and whose structure is simple. The retardation film contains a material whose intrinsic birefringence value is positive and another material whose intrinsic birefringence value is negative. There is a gas barrier layer at least one of the surfaces of the film, and that an oxygen gas permeability of the gas barrier layer in an atmosphere of high temperature and high humidity is not more than 10 ml/m²·day·MPa. The liquid crystal display device is equipped with a pair of substrates and a liquid crystal phase sandwiched by the pair of substrates, and one of the substrates in the pair of substrates has a quarter wave plate characteristic.

### BACKGROUND OF THE INVENTION

1. Field of the Invention

The present invention relates to a retardation film and to a substrate for a liquid crystal display device and a liquid crystal display device using the same. More particularly, the present invention relates to a retardation film which is applicable to portable telephones, portable information terminals, etc. and to a substrate for a liquid crystal display device and a liquid crystal display device using the same.

2. Description of the Related Art

A liquid crystal display device is generally equipped with a liquid crystal cell which is formed by arranging a pair of transparent substrates wherein transparent electrodes are formed so as to face each other, followed by enclosing liquid crystals between the above pair of substrates. When voltage is applied to the transparent electrodes, the liquid crystals are oriented to control the transmission of light whereby an image is expressed. In the conventional liquid crystal display devices, there has been a strong demand for enhancing the luminance of the image and various improvements with the object of enhancement of luminance have been carried out. For example, in Japanese Patent Application Laid-Open No. 10-186357, there is a proposal for a liquid crystal display device in which a retardation film is used such that utilization efficiency of light is improved and expression of an image having a high luminance is possible.

In recent years, the use of liquid crystal display devices has spread to portable telephones, portable information terminals, etc. and, therefore, there has been a demand not only for enhancement of luminance but also for making weight and thickness of the liquid crystal display device light and thin, respectively.

Until now, in a liquid crystal display device, mostly glass has been used for the pair of substrates between which liquid crystals are enclosed. Glass is suitable for use as a substrate since it is optically isotropic and has a high resistance to chemicals and heat. However, as compared with plastic materials, etc., a glass substrate is inferior in terms of shock resistance and easy processability whereby it is not preferred in view of the above-mentioned object of making weight and thickness of the liquid crystal display device light and thin, respectively.

Therefore, as a substitute for the above glass substrate, plastic film has received public attention in recent years. However, in plastic film, birefringence easily expresses when the film is subjected to an elongation treatment, etc. and, unlike glass, it does not show optical isotropy. Accordingly, there have been various proposals to prepare plastic film not expressing birefringence or having no birefringence and to use such as a substrate.

### SUMMARY OF THE INVENTION

In contrast to the above-mentioned plastic film substrate, the present invention utilizes birefringence of a plastic film. Thus, if and when plastic film can be used not only as a substitute for a glass substrate but also as a substrate satisfying the optical characteristics of a retardation film, etc. necessary for a liquid crystal display device utilizing the birefringence, then it is possible to simplify the device by omission of materials and also to satisfy the demand for making weight and thickness of the liquid crystal display device light and thin.

The present invention provides a retardation film which is able to be used as a substrate for a liquid crystal display device and also has excellent durability. The present invention further provides a substrate for a liquid crystal display device whereby weight and thickness of the liquid crystal display device can be made light and thin. The present invention furthermore provides a liquid crystal display device being able to make its weight and thickness light and thin and having a simple structure.

A first aspect of the present invention is a retardation film which is characterized in that there are contained a material whose intrinsic birefringence value is positive and another material whose value thereof is negative, that there is a gas barrier layer on at least one of surfaces of the film, and that an oxygen gas permeability of the gas barrier layer in an atmosphere of high temperature and high humidity is not more than 10 ml/m²·day·MPa.

Another aspect of the present invention is a substrate for a liquid crystal display device having a retardation film and a transparent electroconductive thin membrane formed on the surface of the retardation film, in which retardation film there are contained a material whose intrinsic birefringence value is positive and another material whose intrinsic birefringence value is negative, there is a gas barrier layer on at least one of surfaces of the film and oxygen gas permeability of the gas barrier layer in an atmosphere of high temperature and high humidity is not more than 10 ml/m²·day·MPa.

Since the retardation film has a gas barrier layer on its surface, it is able to prevent deterioration by oxygen gas and has an excellent durability. In addition, since deterioration, etc. of the liquid crystal can be suppressed by the gas barrier layer, it can be used as a substrate for a liquid crystal display device. Moreover, the retardation film can be constituted as a plastic film and, therefore, when it is used as a substrate for a liquid crystal display device, its weight and thickness can be made light and thin, and arrangement of another retardation film is not necessary whereby a simple structure is achieved.

Yet another aspect of the present invention is a liquid crystal display device equipped with a pair of substrates and a liquid crystal layer sandwiched by the pair of substrates, characterized in that, at least one of the pair of substrates has a quarter wave plate characteristic.

In the liquid crystal display device, one of the supports sandwiching the liquid crystal has a characteristic as a quarter wave plate. Accordingly, it is no longer necessary to separately arrange a quarter wave plate with the object of enhancement of luminance, etc., whereby a more simple structure is possible. In addition, when a plastic film is used as a substrate having the quarter wave plate characteristic, it is possible to make its weight and thickness light and thin and, further, shock resistance is improved.

The liquid crystal display device of the present invention may be further equipped with a light-reflecting member which is disposed at an outer side of the substrate having the quarter wave plate characteristic relative to the pair of substrates and also with a polarizing plate which is disposed at an outer side of another substrate of the pair of substrates.

In the liquid crystal display device, a black-and-white display can be implemented by one polarizing plate and, therefore, it is possible to suppress the loss of light caused by repeated transmission of an incident beam through a plurality of polarizing plates. Accordingly, the utilization efficiency of light can be improved and display at a high luminance is possible.

In the liquid crystal display device of the present invention, it is preferred that retardation at wavelength λ, Re(λ), of the substrate having a quarter wave plate characteristic and the wavelength λ satisfy the following formula at each of wavelengths λ=450 nm, 550 nm and 650 nm.

0.2≦Re(λ)/λ≦0.3

In the liquid crystal display device, a broad-range quarter wave plate functioning as a quarter wave plate in terms of the whole range of visible light is used as the substrate having the quarter wave plate characteristic. It is therefore possible to display an image having fresh color tone even when a color image is displayed.

Further, in the liquid crystal display device of the present invention, it is preferred that, in the pair of substrates, the substrate having a quarter wave plate characteristic has a gas barrier layer on at least one of surfaces thereof and has an oxygen gas permeability of not more than 10 ml/m²·day·MPa under an atmosphere of high temperature and high humidity.

In the liquid crystal display device, the substrate having the quarter wave plate characteristic is equipped with a gas barrier layer and, therefore, even when the substrate is composed of a plastic film, deterioration of the liquid crystal molecule by oxygen gas can be prevented and durability can be improved.

The substrate having the quarter wave plate characteristic may be in a structure containing a material whose intrinsic birefringence value is positive and another material whose intrinsic birefringence value is negative. Further, the substrate having the quarter wave plate characteristic may be in a structure that has a first layer formed with a material whose intrinsic birefringence value is positive and a second layer formed with the material whose intrinsic birefringence value is negative, where the first and the second layers have a birefringence and the first and second layers are laminated such that retarded phase axes of the first and second layers cross each other at a right angle. It is preferred that the material whose intrinsic birefringence value is positive is a polymer of a norbornene type while the material whose intrinsic birefringence value is negative is a polystyrene or a polymer of a styrene type. It is particularly preferred that the polymer of a styrene type is a copolymer of at least one of a styrene and styrene derivative with at least one selected from the group consisting of acrylonitrile, maleic anhydride, methyl methacrylate and butadiene.

### BRIEF DESCRIPTION OF THE DRAWINGS

FIG. 1 is a simplified cross-sectional view of a retardation film relating to an embodiment of the present invention.

FIG. 2 is a simplified cross-sectional view of a retardation film relating to another embodiment of the present invention.

FIG. 3 is a simplified cross-sectional view of a liquid crystal display device relating to a further embodiment of the present invention.

### DESCRIPTION OF THE PREFERRED EMBODIMENTS

[Retardation Film]

A retardation film of the present invention contains a material whose intrinsic birefringence value is positive and another material whose intrinsic birefringence value is negative and has a gas barrier layer on at least one of the surfaces of the film. The retardation film of the present invention may be in such a structure that the material whose intrinsic birefringence value is positive and anther material whose intrinsic birefringence value is negative may be contained in a single layer or may be in such a structure that layers, each containing a material whose intrinsic birefringence value is positive or another material whose intrinsic birefringence value is negative, are laminated.

Material whose Intrinsic Birefringence Value is Positive

In the present invention, “a material whose intrinsic birefringence value is positive” (sometimes just referred to as “the positive material” hereinafter) is a material which has a characteristic showing an optically positive uniaxial property when molecules are oriented with a uniaxial order. When the positive material is resin for example, it is a resin where the refractive index of the light in the oriented direction becomes bigger than the refractive index of the light in a direction crossing at a right angle to the oriented direction when light enters a layer formed of molecules in a uniaxial orientation. Examples of the positive material are a polymer of an olefin type (such as polyethylene, polypropylene, a polymer of a norbornene type or a polymer of a cycloolefin type), polymer of a polyester type (such as polyethylene terephthalate and polybutylene terephthalate), polymer of a polyarylene sulfide type (such as polyphenylene sulfide), polymer of a polyvinyl alcohol type, polymer of a polycarbonate type, polymer of a polyallylate type, polymer of a cellulose ester type (some of which may have a negative intrinsic birefringence value), polymer of a polyether sulfone type, polymer of a polysulfone type, polymer of a polyallyl sulfone type, polymer of a polyvinyl chloride type and multi-componential (two-componential, three-componential, etc.) copolymerized polymer thereof. Each of these may be used solely or two or more thereof may be used jointly. In the present invention, a polymer of an olefin type is preferred among these. Among polymers of an olefin type, a polymer of a norbornene type is particularly preferred in view of light transmission characteristic, heat resistance, dimensional stability, optical elasticity characteristic, etc. With regard to the polymer of an olefin type, “ARTON” manufactured by JSR Corporation, “ZEONEX” and “ZEONOR” manufactured by Zeon Corporation, “APO” manufactured by Mitsui Chemicals, Inc., etc. are appropriately utilized.

The polymer of a norbornene type has a norbornene skeleton as a repeating unit. With regard to specific examples thereof, those mentioned in Japanese Patent Application Laid-Open (JP-A) Nos. 62-252406, 62-252407, 2-133413, 63-145324, 63-264626, 1-240517, Japanese Patent Application Publication (JP-B) No.57-8815, JP-A Nos. 5-39403, 5-43663, 5-43834, 5-70655, 5-279554, 6-206985, 7-62028, 8-176411, 9-241484, etc. may be appropriately utilized although the present invention is not limited thereto. Each of them may be used solely or two or more thereof may be used jointly.

Among polymers of a norbornene type, those having a repeating unit represented by any of the following structural formulae (I) to (IV) are preferred in the present invention.

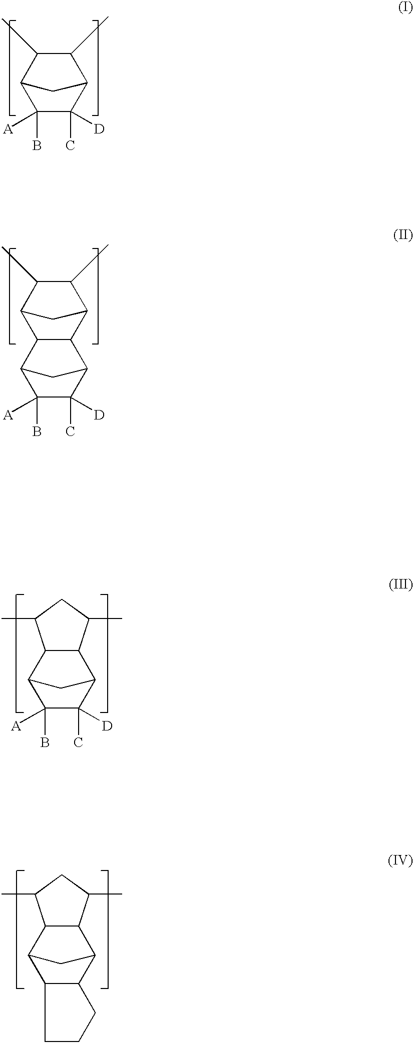

In the above structural formulae (I) to (IV), A, B, C and D each independently is a hydrogen atom or a monovalent organic group.

Among polymers of a norbornene type, a hydrogenated polymer prepared by hydrogenation of a polymer obtained by a metathesis polymerization of at least one of the compounds represented by the following structural formulae (V) and (VI) with an unsaturated cyclic compound which is copolymerizable therewith is also preferred.

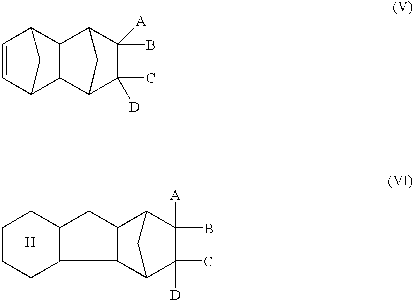

In the above structural formulae A, B, C and D each independently is a hydrogen atom or a monovalent organic group.

A weight-average molecular weight of the polymer of a norbornene type is about 5,000-1,000,000 and, preferably, 8,000-200,000.

Material Whose Intrinsic Birefringence Value is Negative

In the present invention, “a material whose intrinsic birefringence value is negative” (sometimes just referred to as “the negative material” hereinafter) is a material which has a characteristic showing an optically negative uniaxial property when molecules are oriented with a uniaxial order. When the negative material is resin for example, it is a resin where the refractive index of light in the oriented direction becomes smaller than the refractive index of light in a direction crossing at a right angle to the oriented direction when light enters a layer formed of molecules in a uniaxial orientation. Examples of the negative material are polystyrene, a polymer of a polystyrene type (copolymer of at least one of a styrene and styrene derivative with other monomer), polymer of a polyacrylonitrile type, polymer of a polymethyl methacrylate type, polymer of a cellulose ester type (some of which may have a positive intrinsic birefringence value) and multi-componential (two-componential, three-componential, etc.) copolymerized polymer thereof. Each of these may be used solely or two or more thereof may be used jointly. With regard to the polymer of a polystyrene type, a copolymer of at least one of styrene and a styrene derivative with at least one selected from the group consisting of acrylonitrile, maleic anhydride, methyl methacrylate and butadiene is preferred. In the present invention, at least one selected from polystyrene, a polymer of a polystyrene type, polymer of a polyacrylonitrile type and polymer of a polymethyl methacrylate type is preferred among the above. In view of high expression of birefringence, polystyrene and the polymer of a polystyrene type are more preferred among these while, in view of high heat resistance, a copolymer of at least one of a styrene and a styrene derivative with maleic anhydride is particularly preferred among these.

With regard to the polymer of a polystyrene type, a commercially available one may be used. To be specific, “DYLARK D332” manufactured by Nova Chemical, for example, may be preferably used as a commercially available product for a copolymerized resin of styrene with maleic anhydride.

Preferred Combination of the Positive Material with the Negative Material

In the present invention, it is preferred that the materials whose intrinsic birefringence value is positive and is negative are combined according to an index satisfying the following conditions.

When the absolute values of retardation (Re) values at the wavelength of 450 nm and the wavelength of 550 nm are Re(450) and Re(550), respectively, a combination where the value of (Re(450)/Re(550)) of the positive material is not identical with the value of (Re(450)/Re(550)) of the negative material (i.e., one is smaller or larger than another) is preferred. To be more specific, a combination where the difference between these is 0.03 or more is preferred and a combination where the difference is 0.05 or more is more preferred.

In addition, a combination satisfying one of the conditions that, when the value of (Re(450)/Re(550)) of the positive material is larger than the value of (Re(450)/Re(550)) of the negative material, the Re(550) value of the positive material is smaller than the Re(550) value of the negative material and that, when the value of (Re(450)/Re(550)) of the positive material is smaller than the value of (Re(450)/Re(550)) of the negative material, the Re(550) value of the positive material is larger than the Re(550) value of the negative material is preferred.

Now, an illustration will be made for a preferred combination when both of the positive material and the negative material are resin.

When a resin whose wavelength dispersion of the intrinsic refractive value (Δn) is big is used as a negative material, it is preferred to use a resin having the wavelength dispersion of Δn is small as a positive material. When a resin whose wavelength dispersion of the intrinsic refractive value (Δn) is small is used as a negative material, it is preferred to use a resin having the wavelength dispersion of Δn is big as a positive material. For example, if a polymer of a norbornene type is used as the positive material, a resin whose wavelength dispersion of the intrinsic birefringence value is big is preferred as the negative material. To be more specific, it is preferred to select from resins satisfying the following relationship when the intrinsic birefringence values (Δn) at the wavelength of 450 nm and the wavelength of 550 nm are Δn(450) and Δn(550), respectively.

|Δn(450)/Δn(550)|≧1.02

It is more preferred to select from resins satisfying the following relationship.

|Δn(450)/Δn(550)|≧1.05

Incidentally, the greater the value of |Δn(450)/Δn(550)|, the better, but in the case of a resin it is usually 2.0 or less.

To be more specific, when the negative material is polymethyl methacrylate, etc. having a small value of (Re(450)/R(550)), preferred examples of the positive material to be combined therewith are a polymer of a polyethylene terephthalate type, polymer of a polyphenylene sulfide type, polymer of a polycarbonate type, polymer of a polyallylate type, polymer of a polyether sulfone type, polymer of a polysulfone type, polymer of a polyallylsulfone type and polymer of a polyvinyl chloride type.

When the negative material is polystyrene, a polymer of a polystyrene type, etc. having a big value of (Re(450)/Re(550)), preferred examples of the positive material to be combined therewith are a polymer of an olefin type, polymer of a cycloolefin type (such as polyethylene, polypropylene and polymer of a norbornene type) and polymer of a cellulose ester type. Among these, a combination of at least one of a polystyrene and a polymer of a polystyrene type as a negative material with a polymer of a norbornene type as a positive material among polymers of an olefin type is preferred.

<Retardation Film 10>

Now, the embodiments of the present invention will be illustrated.

FIG. 1 shows a brief cross-sectional view of a retardation film concerning an embodiment of the present invention.

The retardation film 10 shown in FIG. 1 has a transparent blend layer 12 including a polymer blend of a resin where the inherent birefringence value is positive and another resin whose intrinsic birefringence value is negative, and a transparent gas barrier layer 14 formed on the blend layer. When the retardation values of the blend layer 12 at the wavelengths of 450 nm, 550 nm and 650 nm are Re(450), Re(550) and Re(650), respectively, there is a relation of Re(450)<Re(550)<Re(650).

The retardation film 10 can be manufactured by various methods. For example, the positive resin and the negative resin are appropriately selected according to the above-mentioned index, a compounding ratio is decided, a miscibilizing agent or the like is added if necessary, and they are compounded. After that, the compounded substance is dissolved in an organic solvent to prepare a coating solution and the coating solution is applied on a support (a preliminary support) followed by drying to give a membrane (a solution membrane manufacturing method). Alternatively, the above compounded substance is made into pellets and subjected to melt-extrusion to give a membrane (extrusion molding method).

When the film prepared by the above method is subjected to an elongation treatment, the blend layer 12 satisfying the relation of Re(450)<Re(550)<Re(650) can be manufactured. Appropriate examples of the elongation treatment are a longitudinally uniaxial elongation where elongation is carried out in a direction of mechanical flow and a transversely uniaxial elongation where elongation is carried out in a direction of crossing the mechanical flow at a right angle (such as tenter elongation) and, provided it is not too much, biaxial elongation may be carried out as well. With regard to details of the adjustment of retardation by elongation, these are the same as in a method for adjusting the retardation in the retardation film of the layered structure, which will be mentioned later.

In the retardation film 10, the molecular orientation of each material is in the same direction in the layer including the polymer blend of the positive resin and the negative resin. When the molecular orientations of the positive resin and the negative resin are made identical, the retarded phase axes naturally cross at a right angle, wavelength dispersion of retardation by each of the materials is offset by the other and it is possible to provide a retardation film giving an almost uniform phase contrast characteristic to the incident light within a whole region of visible light. Accordingly, the retardation film 10 is able to give a uniform phase contrast characteristic to light of a broad region (visible light region) and, at the same time, a layering step for its preparation is not necessary, whereby it is possible to prepare at a low cost using a single material. In addition, since the retardation film 10 has a gas barrier layer 14, it can be used as a substrate for supporting a liquid crystal layer for a liquid crystal display device. Thus, weight and thickness of a liquid crystal display device can be made light and thin and, moreover, the retardation film can also be used as a substrate, whereby it is possible to constitute a liquid crystal display device of simpler structure.

Gas Barrier Layer

The gas barrier layer is a layer having a barrier property to gas, particularly to oxygen. Permeability of oxygen gas under an atmosphere of high temperature and high humidity is preferably not more than 10 ml/m²·day·MPa. The oxygen gas permeability of the gas barrier layer is more preferably not more than 5 ml/m²·day·MPa and still more preferably not more than 3 ml/m² ·day·MPa. Incidentally, in the present invention, the oxygen gas permeability is measured according to a method of JIS K-7126B using, for example, OX-TRAN2/20MH manufactured by Mocon and the resulted value is expressed in the above SI unit. In the present invention, the term “high temperature and high humidity” means a temperature of 60° C. and humidity of 90% RH.

The gas barrier layer may be a layer including either an organic material or an inorganic material. Since a layer including an inorganic material shows a particularly high gas barrier property, the use of an inorganic material is preferred in view of being able to make the gas barrier layer thin. Examples of the organic materials able to form a layer having a gas barrier property are vinylidene chloride polymer and PVA. Examples of inorganic materials able to form a layer having a gas barrier property are metal oxides and specific examples thereof are oxides of alloys of In and Sn, SiOₓ (x=1.0-2.0), Al₂O₃, ZnO and the like. Compounds of a silicon aluminum type such as SiAlON and SiAlN may be preferably used as well. When the gas barrier layer is constituted from an organic material, it can be formed by utilizing a coating method or the like while, when it is constituted from an inorganic material, it can be formed by utilizing a vacuum vapor deposition method, a sputtering method or an ion plating method. When the gas barrier layer is constituted from an inorganic material, the membrane thickness is preferably 10 nm to 500 nm and more preferably 20 nm to 100 nm.

<Retardation Film 10′>

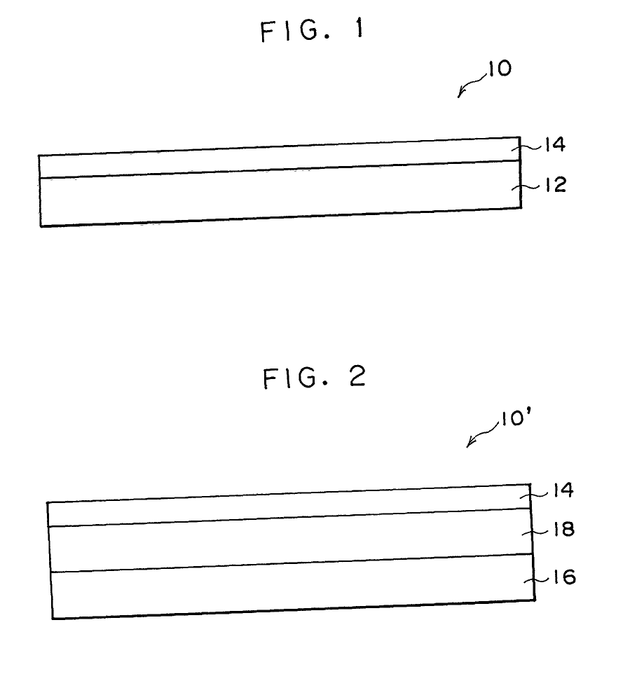

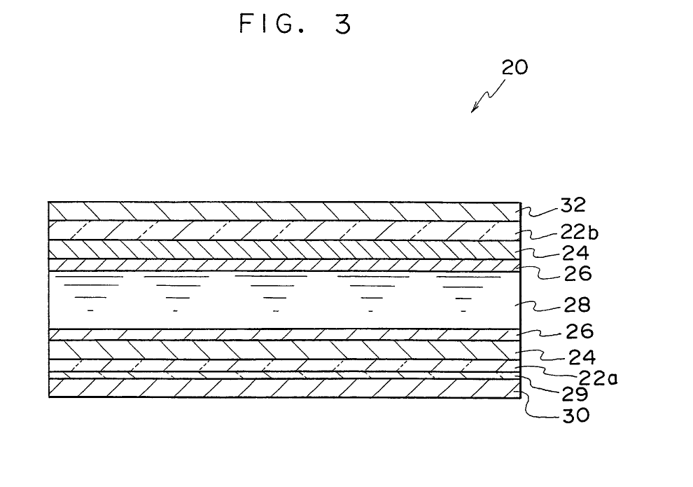

Now, a brief cross-sectional view of a retardation film concerning another embodiment of the present invention is shown in FIG. 2. Incidentally, with regard to the same materials as those in FIG. 1, the same numerals are given and detailed explanation therefor will be omitted.

The retardation film 10′ is in such a structure that a layer 16 including a resin whose intrinsic birefringence value is positive, a layer 18 including a resin whose intrinsic birefringence value is negative and a gas barrier layer 14 are laminated. The layers 16 and 18 have birefringence and are layered such that their retarded phase axes are crossed each other at a right angle. Thus, the oriented direction of the molecules of the positive resin contained in the layer 16 and the oriented direction of the molecules of the negative resin contained in the layer 18 are the same. Retardation of the retardation film 10′ is a sum of the retardation of the layer 16 and that of the layer 18 and, therefore, the retardation of the short wavelength side and that of the long wavelength side of the retardation film 10′ are able to be made small and big, respectively when the layers 16 and 18 are laminated such that the retarded phase axes are crossed each other at a right angle. As a result, the ratio Re(λ)/λ of the retardation at wavelength λ Re(λ) to wavelength λ in the retardation film 10′ can be made almost constant in the whole visible light region.

When values of retardation (Re) at the wavelengths of 450 nm, 550 nm and 650 nm are Re(450), Re(550) and Re(650), respectively, it is preferred that the retardation film in this embodiment satisfies the following formula.

Re(450)<Re(550)<Re(650)

In order to satisfy the above formula, it is preferred that, as the resin whose intrinsic birefringence value is positive, a material whose wavelength dispersion of the intrinsic double refractive value is small is selected while, as the resin whose intrinsic birefringence value is negative, a material whose wavelength dispersion of the intrinsic birefringence value is big is selected and they are combined or, as the resin whose intrinsic birefringence value is positive, a material whose wavelength dispersion of the intrinsic refractive value is big is selected while as the resin whose intrinsic birefringence value is negative, a material whose wavelength dispersion of the intrinsic birefringence value is small is selected and they are combined.

The retardation film of the present invention may be produced by various methods. For example, coating solutions wherein the positive resin and the negative resin are dissolved are prepared, and the solutions are successively applied (or simultaneously applied) on a support (or a preliminary support) and dried to make a membrane whereupon the film is manufactured. It is also possible to manufacture by utilizing co-extrusion. Particularly when the manufacture is carried out by a manufacturing method utilizing the co-extrusion which will be illustrated below, the manufacturing steps can be simplified and the manufacturing cost can be reduced, which is preferred. When co-extrusion is utilized, the resin having a positive intrinsic birefringence value (sometimes just referred to as “the positive resin”) and the resin having a negative intrinsic birefringence value (sometimes just referred to as “the negative resin”) are co-extruded and then the first layer including the resin having a positive intrinsic birefringence value and the second layer including the resin having a negative intrinsic birefringence value are laminated, whereupon a layered product can be manufactured. When the layered product shows the desired retardation, etc., the layered product can be used as a retardation film as it is. If the layered product does not show the desired retardation, a further step where the layered product is elongated to adjust the retardation may be added thereto.

As steps for the manufacture of the above layered product, an example is that the positive resin and the negative resin are placed in extruders, heated and compressed to make each of them in a fluid state and each of them is continuously extruded from a die to give the layered product. After that, the layered product may be continuously passed through a nipping part of nip rollers to adhere with pressure.

An optionally added step for adjusting the retardation by elongating the layered product may be carried out using various kinds of elongating machines. Thus, for example, a longitudinally uniaxial elongation where elongation is carried out in a direction of mechanical flow and a tenter elongation where elongation is carried out in a direction crossing the mechanical flow in a right angle may be appropriately utilized. In addition, it is also possible to provide biaxial properties for controlling the thickness direction. Here, it is preferred that the elongation temperature is set at from (Tgₘᵢₙ−20)° C. to (Tgₘᵢₙ)° C. where Tₘᵢₙ is the lowest glass transition temperature of the basic materials (the positive resin and the negative resin) constituting the layer.

In order to satisfy the characteristic of Re(450)<Re(550)<Re(650), these can be controlled by adjusting weight ratio, elongation temperature, extension rate, etc. of the resins whose intrinsic birefringence values are negative and positive.

For example, a method of adjustment for the case where a polymer of a norbornene type is used as a resin having a positive intrinsic birefringence value and polystyrene is used as a resin having a negative intrinsic birefringence value will be exemplified. The melting/softening temperatures of polystyrene and norbornene-type polymer are Ts and Tn, respectively. Since Ts is lower than Tn, if a layered substance consisting of the layer including norbornene-type polymer and the layer including polystyrene is elongated at a temperature near Tn, orientation relaxation of the polystyrene molecules will be quick, whereby the molecules of the layer including polystyrene will be barely oriented and the layer including polystyrene will have no birefringence. As a result, a layered film where the layer including polymer of a norbornene type and the layer including polystyrene will together have nearly the same wavelength dispersion as shown by the layer including polymer of a norbornene type. As the elongation temperature is made low, the polystyrene molecules start orienting and the layer including polystyrene starts having birefringence. Since retardation of the layer including polystyrene is negative, the positive retardation of the layer including polymer of a norbornene type decreases. With regard to this decreasing rate of retardation, the retardation greatly decreases at the short wavelength side due to wavelength dispersion of the polystyrene and, as a result, the characteristic of Re(450)<Re(550)<Re(650) is achieved. By controlling the elongation temperature, it is possible to prepare a retardation film where Re(λ)/λ is constant within a whole region of visible light wavelengths and a uniform phase-contrast characteristic is available within a broad region. It is also possible by adjustment of the elongation ratio to give characteristics of a ¼-wavelength and a ½-wavelength within a broad region.

In this embodiment, the two layers including the resins having positive and negative intrinsic birefringence values are layered such that the retarded phase axes are crossed at a right angle, whereupon the wavelength dispersions of retardation shown separately by each of the layers are offset by each other and it is possible to provide a retardation film which gives an almost uniform phase-contrast characteristic to the incident light of the whole range of visible light. Further, in order to layer by crossing the retarded phase axes at a right angle for the two layers including the resins whose intrinsic birefringence values are positive and negative, elongating directions of the layers may be simply made the same, whereby it is possible to omit steps of cutting the chip, etc. for making the directions the same. Thus, since the retardation film which is an embodiment of the present invention is a layered product of two resins each having different sign of the intrinsic birefringence value, the retarded phase axes of the two layers can be essentially made crossed at a right angle when the elongating directions of the two layers are made the same, whereby, when co-extrusion and elongating treatment are utilized for example, manufacture by simple steps is now possible without operations such as delicate and complicated angle adjustment during a stage of cutting a chip of film and a stage of adhering the chips, which have been necessary for the preparation of conventional retardation films of a layered type. Thus, the retardation film of this embodiment is able to give a uniform phase contrast characteristic to light of the broad region (visible light region) and, at the same time, in spite of the fact that it is a layered product, it can be manufactured by simple steps at a low cost by utilization of co-extrusion, etc. for the manufacture. Further, since the retardation film 10′ has a gas barrier layer 14, it can be used as a substrate for supporting the liquid crystal layer of a liquid crystal display device and, since it acts as a retardation film as well as a substrate, weight and thickness of the liquid crystal display device can be made light and thin and a liquid crystal display device of simpler structure can be constituted.

In this embodiment, there is shown a retardation film in a structure of having one layer each of resin whose intrinsic birefringence value is positive and negative. However, the retardation film of the present invention is not limited thereto but the film may be in a structure having a third and a fourth layer. As a result of formation of the third and the fourth layers, physical characteristics of the retardation film are improved and, therefore, this is preferred. A layered product having a structure where the cross section of the retardation film is symmetric is particularly preferred. When the third layer includes a resin whose intrinsic birefringence value is positive, such an embodiment that the layers whose intrinsic birefringence values are in the order of positive, negative and positive are successively layered is preferred. When the third layer includes a resin whose intrinsic birefringence value is negative, such an embodiment that the layers whose intrinsic birefringence values are in the order of negative, positive and negative are successively layered is preferred. Further, in an embodiment of a three-layered structure, it is preferred that, with regard to layers including the resin having the same sign of the intrinsic birefringence value, they are layered such that their retarded phase axes are made the same. Furthermore, it is preferred that the resins where the sign of the intrinsic birefringence value is the same contain the same material.

It is also possible that, between a layer including a resin whose intrinsic birefringence value is positive and a layer including a resin whose intrinsic birefringence value is negative, a layer which enhances the adhesion of both layers (hereinafter, referred to as “adhesive layer”) may be placed. For the layer, a material which has an affinity to both resins having positive and negative intrinsic birefringence values may be used. It is preferred that, for example, when the polymer of a norbornene type is used as the resin whose intrinsic birefringence value is positive while polystyrene (or polymer of a polystyrene type) is used as the resin whose intrinsic birefringence value is negative, it is preferred that the adhesive layer is a layer containing any of the components of a polymer of an olefin type and polystyrene (or polymer of a styrene type) and is a layer including a polymer having a glass transition point which is at least 5° C. (or, more preferably, 10° C.) lower than those of the positive resin and the negative resin. The present invention is, however, not limited thereto. Incidentally, in the adhesive layer, the lower a multiplication product of birefringence and thickness, the better.

In the formation of a retardation film having the adhesive layer between the layer including the positive resin and the layer including the negative resin, it is preferred to use a resin having a lower melting/softening temperature than the elongation temperature as the resin constituting the adhesive layer. To be more specific, the use of a resin having a low glass transition point is preferred, and the use of a resin having a 5° C. or more lower glass transition temperature than the resin having a positive intrinsic double refractive value and the resin having a negative intrinsic double refractive value is more preferred, and far more preferably a Tg 20° C. or more lower than the same.

When the retardation film of the present invention is used as a circular polarization plate (quarter wave plate), it is preferred that the value of “retardation(Re)/wavelength” is 0.2-0.3 within a broad range of wavelengths of 450-650 nm or at least at the wavelengths of 450 nm, 550 nm and 650 nm. More preferably, the value of “retardation(Re)/wavelength” is 0.23-0.27 at least at the wavelengths 450 nm, 550 nm and 650 nm and, still more preferably, is 0.24-0.26. When the retardation film of the present invention is used as a λ/2 plate, it is preferred that the value of “retardation(Re)/wavelength” is 0.40-0.60 within a broad range of wavelengths of 450-650 nm or at least at the wavelengths 450 nm, 550 nm and 650 nm. More preferably, the value of “retardation(Re)/wavelength” is 0.46-0.54 at least at the wavelengths 450 nm, 550 nm and 650 nm and, still more preferably, is 0.48-0.52.

In the retardation film of the present invention, optical elasticity is preferably not more than 20 Brewsters and, more preferably, is not more than 10 Brewsters, and is further preferably not more than 5 Brewsters. When a retardation film is used as a member for a display element etc., it is usually adhered to another member (such as a polarizing plate). There is a deviation in the stress applied in the adhesion and, as compared with the central area, stronger stress is applied at an edge. As a result, a difference is caused in the retardation whereby the edge is whitish and pale and, in display elements, this may lower the display characteristic. When the optical elasticity of the retardation film is within the above range, it is possible to suppress the partial difference in retardation even when there is a deviation in the stress upon adhesion, whereby it is more advantageous as a material for a display element, etc.

[Substrate for Liquid Crystal Display Device]

The retardation film of the present invention is preferably utilized in the liquid crystal display device of the present invention, which will be mentioned later, as a substrate for the liquid crystal display device. As mentioned already, it is preferably used not only as an optical member such as a quarter wave plate but also as a substrate for supporting a liquid crystal layer. Especially when a retardation film where the gas barrier layer (transparent electrode layer if desired) is formed on the surface of the elongated film having a quarter wave plate characteristic and having an adjusted retardation by elongation is used as a substrate for a liquid crystal display device of a reflection type, a liquid crystal display device of a reflection type with which display with a high luminance is possible is possible, and that is preferred. Incidentally, when the retardation film of the present invention is used as a substrate of a liquid crystal display device, another substrate sandwiching the liquid crystal layer together with the retardation film may be a glass substrate or a plastic film. With an object of making the weight light and the thickness thin, plastic film is preferred and, preferably, the plastic film is optically isotropic. When the retardation film of the present invention is used as a substrate as mentioned above, the retardation film may be equipped with an electrode for supplying voltage to a liquid crystal layer supported thereby. The electrode can be constituted by forming a transparent electroconductive thin membrane on the surface of one side (the surface of the side where no gas barrier layer is formed is preferred) of the retardation film. The transparent electroconductive layer may be formed by means of vacuum vapor deposition, sputtering, ion plating, etc. using indium-tin oxide (ITO), tin oxide (SnO₂), etc. Thickness of the transparent electroconductive layer is preferably 10-400 nm and, more preferably, 50-200 nm. Sheet resistance is preferably not more than 100 Ω/□ and, more preferably, 50 Ω/□. Incidentally, the transparent electroconductive layer may be patterned in stripes or in segments if desired. Etching, etc. may be utilized for the patterning.

[Liquid Crystal Display Device]

Now, a liquid crystal display device which is an embodiment of the present invention will be illustrated.

In FIG. 3, there is shown a brief cross-sectional view of a liquid crystal display device 20 as a further embodiment of the present invention.

The liquid crystal display device 20 is equipped with a pair of transparent substrates 22a and 22b and a liquid crystal layer 28 which is sandwiched by the transparent substrates 22a and 22b. A transparent electrode layer 24 and a transparent oriented membrane 26 are successively formed between each of the transparent substrates 22a and 22b and the liquid crystal layer 28. An optical reflection layer 30 is placed on the back of the transparent substrate 22a while a polarizing plate 32 is placed on the front of the transparent substrate 22b. On the surface of the side of the transparent substrate 22a facing the optical reflection layer 30, a transparent gas barrier layer 29 is formed. The transparent substrate 22a has a characteristic as a quarter wave plate.

The transparent electrode layer 24 includes a metal oxide such as ITO and may be patterned, for example, in stripes or segments. The transparent oriented membrane 26 includes an organic polymer such as polyimide or PVA. The transparent electrode layer 24 and the transparent oriented membrane 26 are formed with an object of controlling the orientation of liquid crystal molecules contained in the liquid crystal layer 28, but when orientation of the liquid crystal molecules is able to be controlled by another method, these layers may be omitted.

The transparent substrate 22a includes an elongated plastic film and has a characteristic as a quarter wave plate. An example thereof is an elongated film which is a layered substance consisting of a layer including a material having a positive birefringence value and a layer including a material having a negative birefringence value, which will be mentioned later. The transparent substrate 22b may be a glass substrate or a plastic film and, in view of making the weight light and the thickness thin and of having a high shock resistance, a plastic film is preferred. When the transparent substrate 22b includes a plastic film, it is preferred that the plastic film is a film showing no birefringence.

A liquid crystal layer 28 is a liquid crystal layer of a nematic type in a state of twisted orientation. When no voltage is applied between the transparent electrode layers 24, a liquid crystal molecule adjacent to an oriented membrane 26 at the side of the transparent substrate 22a and a liquid crystal molecule adjacent to an oriented membrane 26 at the side of the transparent substrate 22b are in a 45°-twisted orientation. On the other hand, when a higher voltage than a liquid crystal saturated voltage is applied between the transparent electrode layers 24, the liquid crystal molecules are vertically oriented to the transparent substrates 22a and 22b. In the meanwhile, a polarizing axis of the polarizing plate 32 and an anisotropic axis of the transparent substrate 22a, which is a quarter wave plate, are oriented in such a manner that, when projected on the same plane, they cross in an angle of 45°.

Now, the image display characteristics of the liquid crystal display device 20 will be illustrated.

When light comes onto the polarizing plate 32 in such a state that no voltage is supplied between the transparent electrode layers 24, only the linearly polarized light component parallel to the polarizing axis of the polarizing plate 32 among the incident light transmits and comes onto the liquid crystal layer 28. Since the liquid molecules are in a 45°-twisted state in the liquid crystal layer 28, the linearly polarized incident light component rotates to an extent of 45° due to orientation of the liquid crystal molecules. The polarized light direction of the linearly polarized light coming out from the liquid crystal layer 28 becomes parallel to the anisotropic axis of the transparent substrate 22a and the linearly polarized light transmits through the transparent substrate 22a as it is without being given a phase contrast. After that, the light is reflected by the optical reflection layer 30, transmits through the transparent substrate 22a and comes to the liquid crystal layer 28 again. The linearly polarized light coming onto the liquid crystal layer 28 is rotated to an extent of −45° by orientation of the liquid crystal molecules and, therefore, its polarized light direction becomes parallel to the polarizing axis of the polarizing plate 32 and is able to transmit through the polarizing plate 32, giving a bright white display.

On the other hand, when incident light comes to the polarizing plate 32 in such a state that a higher voltage than the liquid crystal saturated voltage is applied between the transparent electrode layers 24, only the linearly polarized light component parallel to the polarizing axis of the polarizing plate 32 transmits therethrough among the incident light coming at the same time and comes onto the liquid crystal layer 28. In the liquid crystal layer 28, the liquid crystal molecules are not oriented and, therefore, the linearly polarized light as it is comes onto the transparent substrate 22a without rotating its polarized direction, and a phase contrast is given thereto by the quarter wave plate characteristic of the transparent substrate 22a. After that, the light is reflected by the light reflection layer 30 and passes through the transparent substrate 22a again being given a phase contrast. Thus, until the linearly polarized light component transmitting through the polarizing plate 32 arrives the polarizing plate 32 again, it passes through the transparent substrate 22a which is a quarter wave plate twice and, therefore, the polarized direction of the linearly polarized light is rotated to an extent of 90°. The linearly polarized light component which is reflected and passes through the polarizing plate 32 again has an angle of 90° to the polarizing axis of the polarizing plate 32 and, therefore, it is unable to transmit through the polarizing plate 32, giving black expression.

Although only a black-and-white display is described hereinabove, display in a neutral tone can be expressed when a voltage which is lower than the liquid crystal saturated voltage is applied. Further, when a color filter is placed between the substrate 22b and the polarizing plate 32, for example, expression of multi-color images is possible.

The liquid crystal display device of the present invention may be equipped with other members. For example, a protective layer may be placed on the surface of the polarizing plate. Further, a spacer giving a predetermined gap may be placed between the transparent substrates 22a and 22b. Furthermore, a sealing member into which liquid crystal molecules are enclosed to form the liquid crystal layer may be equipped therewith.

In this embodiment, only one polarizing plate is used and, therefore, it is possible to suppress the loss of light caused by repeated passages of the light through the polarizing plate. As a result, the utilizing efficiency of the light is enhanced and a display in a high luminance is achieved. Further, in this embodiment, the substrate acts as a quarter wave plate as well and, therefore, it is possible to constitute a liquid crystal display device of a reflection type with which a bright display is possible by simpler structure. Furthermore, when the quarter wave plate is constituted by a plastic film such as an elongated film, it is possible to make the weight light and the thickness thin.

Incidentally, the angle of the polarizing axis of the polarizing plate 32 to the anisotropic axis of the quarter wave plate (substrate 22a) is not limited to 45° but may vary depending upon the twist angle of the liquid crystal layer 28.

¼-wavelength Substrate

Now, a substrate having a characteristic as a quarter wave plate (hereinafter, sometimes abbreviated as “the ¼-wavelength substrate”) will be illustrated in detail. As the ¼-wavelength substrate, various widely known quarter wave plates may be utilized. It is preferred that the ¼-wavelength substrate has a characteristic as a quarter wave plate within a broad region and, to be more specific, that retardation Re(λ) at wavelength λ and the wavelength λ satisfy the following relation at each of the wavelengths 450 nm, 550 nm and 650 nm.

0.2≦Re(λ)/λ≦0.3

It is preferred that an optical elasticity of the ¼-wavelength substrate is not more than 20 Brewsters, more preferably not more than 10 Brewsters and, far more preferably, not more than 5 Brewsters. For example, when the ¼-wavelength substrate is adhered to an optical reflection layer, there is a deviation in the stress applied in the adhesion and, as compared with a central area, stronger stress is applied at an edge. As a result, a difference results in the retardation whereby the edge is whitish and pale, and this may lower the display characteristics. When the optical elasticity of the ¼-wavelength substrate is within the above range, it is possible to suppress the partial difference in the retardation even when there is a deviation in the stress upon adhesion, which is more advantageous.

When the ¼-wavelength substrate is constituted using a material whose intrinsic birefringence value is positive and another material whose intrinsic birefringence value is negative, it is possible to counterbalance the wavelength dispersion characteristics and to prepare a ¼-wavelength substrate having a broad range by adjusting the compounding amounts, elongating conditions, etc. and that is preferred. In addition, when a material whose intrinsic birefringence value is positive and another material whose intrinsic birefringence value is negative are used, it is possible to prepare a broad-range ¼-wavelength substrate by simple steps as a result of utilization of co-extrusion, elongation treatment, etc. and that is preferred. Incidentally, the ¼-wavelength substrate may be constituted in such a manner that the material whose intrinsic birefringence value is positive and the material whose intrinsic birefringence value is negative are contained in a single layer or may be constituted in such a manner that the materials are contained in separate layers and such layers are laminated.

Details concerning the material whose intrinsic birefringence value is positive and the material whose intrinsic birefringence value is negative are the same as those concerning the material whose intrinsic birefringence value is positive and the material whose intrinsic birefringence value is negative mentioned under the heading

[Retardation Film]

It is preferred that the ¼-wavelength substrate is equipped with a gas barrier layer on the surface of at least one side thereof. When a gas barrier layer is equipped therewith, deterioration of liquid crystal molecules by oxygen, etc. can be suppressed, whereby display of images of high luminance over a long period is possible.

Details concerning the above-mentioned gas barrier layer are the same as those concerning the gas barrier mentioned under the heading [Retardation film].

With regard to the substrate having a ¼-wavelength characteristic utilizing the positive material and the negative material, the retardation films 10 and 10′ which are embodiments of the present invention are advantageously used. Thus, a preferably used one is a ¼-wavelength substrate of a laminated type in such a structure that a ¼-wavelength substrate having a blend layer, which includes a polymer blend of a resin whose intrinsic birefringence value is positive and another resin whose intrinsic birefringence value is negative, and a gas barrier layer formed on the blend layer, or a layer which includes a resin whose intrinsic birefringence value is positive, a layer which includes a resin whose intrinsic birefringence value is negative and a gas barrier layer are laminated.

The ¼-wavelength substrate of the laminated type may also have third and fourth layers including the positive or the negative resin. It is also possible that a layer (adhesive layer) for enhancing adhesion of layers between the layer including the positive resin and the layer including the negative resin is provided.

Details of the quarter wave plate are the same as those mentioned under the heading [Retardation film] and can be produced in the same manner as in the above-mentioned retardation film of the present invention.

Besides the above, a quarter wave plate including a modified polycarbonate mentioned in the specification of WO 00/26705, a laminated product of two optical anisotropic layers mentioned in the Japanese Patent Laid-Open No. 2000-206331, cellulose acetate mentioned in the Japanese Patent Laid-Open Nos. 10-310370 and 10-137116, etc. may also be used as the quarter wave plate.

### EXAMPLES

The present invention will be illustrated in more detail. The present invention is not limited by the following Examples at all.

### Example 1

A norbornene resin of a cycloolefin type (trade name: “ZEONOR 1420R” manufactured by Nippon Zeon) was used as a resin whose intrinsic birefringence value was positive while a polystyrene-maleic anhydride copolymer (trade name: “DYLARK D332” manufactured by Nova Chemical) was used as a resin whose intrinsic birefringence value was negative. With regard to such resins, those which had been previously dried under purging with nitrogen to reduce the water content were used.

Incidentally, the value of (Re(450)/Re(550)) of the norbornene resin of a cycloolefin type was 1.005 while the value of (Re(450)/Re(550)) of the polystyrene-maleic anhydride copolymer was 1.080 where Re(450) and Re(550) are the absolute values of retardation (Re) at the wavelengths of 450 nm and 550 nm, respectively. Thus, they were not identical but had a difference of 0.075.

The resins were charged in an inner area of an extruder (“LABO PLASTOMILI” manufactured by Toyo Seiki) and subjected to co-extrusion to prepare a laminated product in a three-layered structure (norbornene resin/polystyrene resin/norbornene resin) followed by subjecting to an elongation treatment to prepare a quarter wave plate. A die of the extruder was equipped with two extruding devices and was in such a structure that the resin hoppers received in the devices were joined in an inner area of the die. One extruding device had two openings and there was such a structure that, in the inner area of the die, a resin hopper 1 extruded from one of the extruding devices became a center while resin hoppers 2 extruded from the two openings of another extruding device (having two openings) joined from both sides of the resin hopper 1. Under the dies, a plurality of rollers were placed providing such a structure that control of thickness of the three-layered laminated product extruded from the die was possible.

The hopper of the resin of a polystyrene type was charged in an extruding device while the hopper of the resin of a norbornene type was charged in another extruding device having two openings, and a melt-molded film in a three-layered structure including norbornene resin/polystyrene resin/norbornene resin was prepared. Thickness of the laminated film was adjusted by controlling a peripheral velocity of plural rollers to give a laminated film having a thickness of 102 μm. The resulting laminated film was subjected to an elongation treatment of 19% in an atmosphere of 95° C. to give an elongated film. Dependency of Re on the wavelength was measured for the resulting 19%-elongated film using “KOBRA 21 DH” manufactured by Oji Keisoku, whereupon it was found that the elongated film had a broad-range quarter wave plate characteristic where Re showed ¼ of the wavelength throughout the whole visible light region. When an optical elasticity of the resulting elongated film was measured using “M-150” manufactured by Nippon Bunko, it was found to be 4 Brewsters.

After that, SiO_{1.8} was sputtered on the norbornene resin layer of the resulting elongated film to form a gas barrier membrane having a thickness of about 50 nm. Then, ITO was sputtered on the norbornene resin layer on the side where the gas barrier layer was not formed to form a thin electroconductive membrane having a thickness of about 100 nm, which was patterned into stripes by means of etching to prepare a substrate having a function of a retardation film. A sheet resistance value and an oxygen gas permeability at the temperature of 60° C. and the humidity of 90% RH of the resulting substrate having the retardation film characteristic were 20 Ω/□ and 7 ml/m²·day·MPa, respectively showing a sufficient barrier property as a substrate for a liquid crystal display device.

As fully illustrated hereinabove, the present invention is able to provide a retardation film which can be used as a substrate for a liquid crystal display device. The present invention is further able to provide a retardation film having excellent durability. The present invention is furthermore able to provide a substrate for a liquid crystal display device whereby weight and layer of a liquid crystal display device can be made light and thin, respectively.

### Example 2

A liquid crystal display device as show in FIG. 3 was prepared. First, as the substrate 22a, the following ¼-wavelength substrate was prepared.

A norbornene resin of a cycloolefin type (trade name: “ZEONOR 1420R” manufactured by Nippon Zeon) was used as a resin whose intrinsic birefringence value was positive while polystyrene (trade name: “HF-77” manufactured by A. & M. Styrene) was used as a resin whose intrinsic birefringence value was negative. With regard to such resins, those which had been previously dried under purging with nitrogen to reduce the water content were used.

Incidentally, the value of (Re(450)/Re(550)) of the norbornene resin of a cycloolefin type was 1.005 while the value of (Re(450)/Re(550)) of the polystyrene was 1.080 where Re(450) and Re(550) are the absolute values of retardation (Re) at the wavelengths of 450 nm and 550 nm, respectively. Thus, they were not identical but had a difference of 0.075.

The resins were charged in the inner area of an extruder (“LABO PLASTOMILI” manufactured by Toyo Seiki) and subjected to co-extrusion to prepare a laminated product in a three-layered structure (norbornene resin/polystyrene/norbornene resin) followed by subjecting to an elongation treatment to prepare a quarter wave plate. A die of the extruder was equipped with two extruding devices and was in such a structure that the resin hoppers received in the devices were joined in an inner area of the die. One extruding device had two openings and there was such a structure that, in the inner area of the die, a resin hopper 1 extruded from one of the extruding devices became a center while resin hoppers 2 extruded from the two openings of another extruding device (having two openings) joined from both sides of the resin hopper 1. Under the die, a plurality of rollers were placed providing such a structure that control of thickness of the three-layered laminated product extruded from the die was possible.

The hopper of the polystyrene was charged in an extruding device while the hopper of the resin of a norbornene type was charged in another extruding device having two openings, and a melt-molded film in a three-layered structure including norbornene resin/polystyrene/norbornene resin was prepared. Thickness of the laminated film was adjusted by controlling peripheral velocity of plural rollers to give a laminated film having a thickness of 102 μm. The resulting laminated film was subjected to an elongation treatment of 19% in an atmosphere of 95° C. to give an elongated film. Dependency of Re on the wavelength was measured for the resulting 19%-elongated film using “KOBRA 21 DH” manufactured by Oji Keisoku whereupon it was found that the elongated film had a broad-range quarter wave plate characteristic where Re showed ¼ of the wavelength throughout the whole visible light region. When an optical elasticity of the resulting elongated film was measured using “M-150” manufactured by Nippon Bunko, it was found to be 8 Brewsters. This was used as the ¼-wavelength substrate 22a.

After that, SiO_{1.8} was sputtered on the norbornene resin layer of the resulting substrate 22a to form the gas barrier membrane 29 having a thickness of about 50 nm. Then, ITO was sputtered on the norbornene resin layer on the side where the gas barrier layer 29 was not formed to form the thin transparent electroconductive membrane 24 having a thickness of about 100 nm, which was patterned into stripes by means of etching. A sheet resistance value and oxygen gas permeability at the temperature of 60° C. and the humidity of 90% RH of the resulting substrate 22a were 20 Ω/□ and 7 ml/m²·day·MPa, respectively.

As the substrate 22b, a laminated film before subjecting to an elongation treatment in the manufacture of the substrate 22a was used. The same as in the case of the substrate 22b, a gas barrier layer (not shown in FIG. 3) and the transparent electroconductive membrane 24 were formed on the laminated film.

The polarizing plate 32 was arranged in such a manner that, when the polarizing axis of the polarized light plate 32 and the anisotropic axis of the substrate 22a were projected to the same plane, they crossed in an angle of 45°. Further, the substrates 22a and 32b were placed with a predetermined interval by a spacer (not shown in FIG. 3) being faced to the transparent electroconductive membrane 24, and liquid crystal molecules were sealed into the gap to form the liquid crystal layer 28. In a state where no voltage was applied to the transparent electroconductive membrane 24, the liquid crystal molecules had such an orientation that a liquid crystal molecule adjacent to the oriented membrane 26 at the side of the substrate 22a and a liquid crystal molecule adjacent to the oriented membrane 26 at the side of the substrate 22b were twisted in an angle of 45° by the polyamide oriented membrane 26 formed on the substrates 22a and 22b. On the other hand, in a state where voltage higher than the liquid crystal saturated voltage was applied to the transparent electroconductive membrane 24, the liquid crystal molecules were vertically oriented to the substrates 22a and 22b.

Those members were pasted together to prepare the liquid crystal display device 20 having a structure as shown in FIG. 3. In a state where no voltage was applied to the transparent electroconductive thin membrane 24, the liquid crystal display device 20 expressed black and in a state where a higher voltage than the liquid crystal saturated voltage was applied to the transparent electroconductive thin membrane 24 it expressed bright white. Accordingly, the liquid crystal display device 20 was able to give good white-and-black expression without arranging a retardation film separately. Further, since both the substrates 22a and 22b were plastic films, they were in very thin layers and light in weight. Furthermore, since no glass was used in the substrates, shock resistance was good as well.

As fully illustrated hereinabove, it is possible to make the weight light and the thickness thin and to provide a liquid crystal display device having a simple structure according to the present invention.

What is claimed is:

1. A retardation film comprising:
a material whose intrinsic birefringence value is positive;
another material whose intrinsic birefringence value is negative; and
a gas barrier layer on at least one of surfaces of the film,
wherein oxygen gas permeability of the gas barrier layer in an atmosphere of high temperature and high humidity is not more than 10 ml/m²·day·MPa.

2. The retardation film according to claim 1, wherein the retardation film comprises a first layer formed with the material whose intrinsic birefringence value is positive and a second layer formed with the material whose intrinsic birefringence value is negative, the first and the second layers having birefringence, and the first and second layers being layered such that retarded phase axes of the first and second layers cross each other at a right angle.

3. The retardation film according to claim 2, wherein a direction of orientation of molecular chains in the first layer and a direction of orientation of molecular chains in the second layer are the same.

4. The retardation film according to claim 2, further comprising a third layer which includes a material whose intrinsic birefringence value is one of positive and negative, wherein the third layer has birefringence, and the first, second and third layers are successively laminated such that adjacent layers thereof are different in terms of positivity and negativity of the intrinsic birefringence values.

5. The retardation film according to claim 1, wherein the material whose intrinsic birefringence value is positive comprises a polymer of a norbornene type.

6. The retardation film according to claim 1, wherein the material whose intrinsic birefringence value is negative comprises one of polystyrene and a polymer of a styrene type.

7. The retardation film according to claim 6, wherein the polymer of a styrene type comprises a copolymer of at least one of a styrene and a styrene derivative with at least one selected from the group consisting of acrylonitrile, maleic anhydride, methyl methacrylate and butadiene.

8. The retardation film according to claim 1, wherein optical elasticity is not more than 10 Brewsters.

9. The retardation film according to claim 1, wherein λ, a wavelength value, and Re(λ), a retardation at wavelength λ, satisfy the following relationship at each of wavelengths λ=450 nm, 550 nm and 650 nm:
0.2≦Re(λ)/λ≦0.3.

10. The retardation film according to claim 1, wherein the gas barrier layer comprises inorganic material and comprises a thin membrane having a thickness of from 10 nm to 500 nm.

11. A substrate for a liquid crystal display device having a retardation film and a transparent electroconductive thin membrane formed on the surface of the retardation film, wherein the retardation film comprises:
a material whose intrinsic birefringence value is positive;
another material whose intrinsic birefringence value is negative; and
a gas barrier layer on at least one of surfaces of the film,
wherein oxygen gas permeability of the gas barrier layer in an atmosphere of high temperature and high humidity is not more than 10 ml/m²·day·MPa.

12. A liquid crystal display device equipped with a pair of substrates and a liquid crystal layer sandwiched by the pair of substrates, wherein at least one of the pair of substrates has a quarter wave plate characteristic.

13. The liquid crystal display device according to claim 12, further comprising a light-reflecting member which is disposed at an outer side of the substrate having the quarter wave plate characteristic, and a polarizing plate which is disposed at an outer side of another substrate of the pair of substrates.

14. The liquid crystal display device according to claim 12, wherein, at the substrate having the quarter wave plate characteristic, λ, a wavelength value, and Re(λ), a retardation at wavelength λ, satisfy the following relationship at each of wavelengths λ=450 nm, 550 nm and 650 nm:
0.2≦Re(λ)/λ≦0.3.

15. The liquid crystal display device according to claim 12, wherein the substrate having the quarter wave plate characteristic comprises a gas barrier layer on at least one of surfaces thereof, and oxygen gas permeability of the gas barrier layer in an atmosphere of high temperature and high humidity is not more than 10 ml/m²·day·MPa.

16. The liquid crystal display device according to claim 12, wherein the substrate having the quarter wave plate characteristic comprises a material whose intrinsic birefringence value is positive and another material whose intrinsic birefringence value is negative.

17. The liquid crystal display device according to claim 16, wherein the substrate having the quarter wave plate characteristic comprises a first layer formed with the material whose intrinsic birefringence value is positive and a second layer formed with the material whose intrinsic birefringence value is negative, the first and the second layers having birefringence, and the first and second layers being layered such that retarded phase axes of the first and second layers cross each other at a right angle.

18. The liquid crystal display device according to claim 16, wherein the material whose intrinsic birefringence value is positive comprises a polymer of a norbornene type.

19. The liquid crystal display device according to claim 16, wherein the material whose intrinsic birefringence value is negative comprises one of polystyrene and a polymer of a styrene type.

20. The liquid crystal display device according to claim 19, wherein the polymer of a styrene type comprises a copolymer of at least one of a styrene and a styrene derivative with at least one selected from the group consisting of acrylonitrile, maleic anhydride, methyl methacrylate and butadiene.
